(19) United States
(12) Patent Application Publication
(10) Pub. No.: US 2007/0288324 A1
(43) Pub. Date: Dec. 13, 2007

(54) Method for Guided Shopping and Translation Services

(76) Inventors: Donald H. Skelton, Bonita Springs, FL (US); Tomio Uchimura, Kamakura-shi (JP)

Correspondence Address: Dickinson Wright PLLC, 38525 Woodward Avenue, Suite 2000, Bloomfield Hills, MI, 48304, US

(21) Appl. No.: 11/422,761

(22) Filed: Jun. 7, 2006

(51) Int. Cl. G06Q 30/00

(52) U.S. Cl. 705/26

(57) ABSTRACT

An online interactive guided shopping and product evaluation system is disclosed. Translation services can be provided as needed. The business owners participate in a network and have in-store cameras to allow the customers to evaluate the merchandise and to secure additional information. Video conferencing is also available as needed. The camera can be operated by any of the parties in order to better view the store or business or products at issue. Translation services can be provided as needed.

### TECHNICAL FIELD

The present invention relates to internet systems, and more particularly to systems which provide enhanced online services to customers and others looking for additional information over the internet.

### BACKGROUND OF THE INVENTION

The internet or worldwide web is in common use today by persons seeking information and details relative to virtually all fields of endeavor. The internet and web are in particular wide use today for persons who are looking to acquire various products and other merchandise which are advertised on the web.

When customers are in the process of acquiring products through the internet, they typically have to select products from pictures and written descriptions of products. In some cases, video clips may be available of some of the products or a website can be used for additional information. Although these methods of internet shopping have proved to be convenient and successful for the companies selling the merchandise and the purchasers, customers often have questions relative to additional alternative selections or to features of the products which are not shown or described in the website. In addition, it is difficult for the customers to be able to contact or discuss these matters directly with personnel from the selling companies.

Moreover, since the internet and web are international, the situation often arises in which there are language difficulties or differences between the buyers and the persons interested in acquiring the merchandise.

It is an object of the present invention to provide an improved system for providing information to persons utilizing the internet. It is also an object of the present invention to provide the ability for customers or prospective customers to obtain additional information concerning products or services advertised on the internet. It is a further object of the present invention to provide translation services for sellers on the one hand and customers or prospective customers on the other hand in order for transactions to be completed between persons who speak different languages.

### SUMMARY OF THE INVENTION

The present invention fulfills these objects and provides an improved internet based system. This system provides an enhanced on-line service and procedure in which customers or prospective customers can obtain additional information concerning certain subject matter, such as a product, and can also communicate with the sellers even though there are language differences involved. The persons or businesses offering the goods or services have web cams or the like in their premises which are connected through the internet for possible use. Preferably, the web cams have appropriate controls so they can be moved or manipulated in order to alter the view or to show various aspects of the products or services at issue.

When an on-line user desires to view additional features or details of a product or service, the parties communicate on-line and the web cam can be manipulated in order to disclose or show the features desired. This is done in real time. In addition, other parties or persons can be added to the discussion via video conferencing procedures.

If there is a language difficulty between the business owner or seller on the one hand and the customer or prospective customer on the other hand, then translation services are also provided by the present invention. In particular, once it is established that a certain type of translation is needed, either party can invite an appropriate language translator to join the conference or web cam session, or an appointment can be scheduled between the parties and the translator. In this manner, the viewing experience and web cam manipulation can be carried out with the translator providing the necessary audio portion. The system also can be activated or utilized 24/7.

Where an appointment with a translator is scheduled, reminder messages to the parties can be automatically generated by the present invention. In this manner, the appointment for the translation services is not missed.

The camera in the store or place of business can also pan the store showing all the merchandise available and can double as a security camera when not in use for commercial operations. The customer or prospective customer also can have the ability to control the web camera and can zoom in on items of interest. In the alternative, the control of the camera can move between the business owner and the customer or prospective customer or other interested parties where desired.

Once the customer or prospective customer has explored the situation or secured additional information of interest, than the business owner and customer can proceed to conclude the matter in a conventional manner.

Other features, benefits and advantages of the present invention will become apparent from the following description of the invention when viewed in accordance with the accompanying drawings and appended claims.

### BRIEF DESCRIPTION OF THE DRAWINGS

FIG. 1 is a flow diagram of one embodiment of the invention.

FIG. 2 is flow diagram depicting a method in accordance with the present invention.

FIG. 3 is a wheel-type diagram illustrating an embodiment of the invention.

### DESCRIPTION OF THE PREFERRED EMBODIMENT(S)

The present invention provides a unique and beneficial on-line interactive experience for both business owners or sellers on the one hand and persons or buyers seeking information on the other hand, such as customers or prospective customers. In particular, the present invention is particularly suited for customers and others who desire additional information about products and services which are promoted or shown on the internet The invention also allows persons from various countries and/or speaking different languages to be able to secure the same benefits and advantages. The system also preferably is available for use and can be used 24/7 throughout the world.

Although the present invention is described relative to shopping experiences in which a customer or prospective customer is looking into or attempting to buy a product on the internet, it is understood that the present invention can be utilized in a wide variety of applications and is not limited only to shopping experiences.

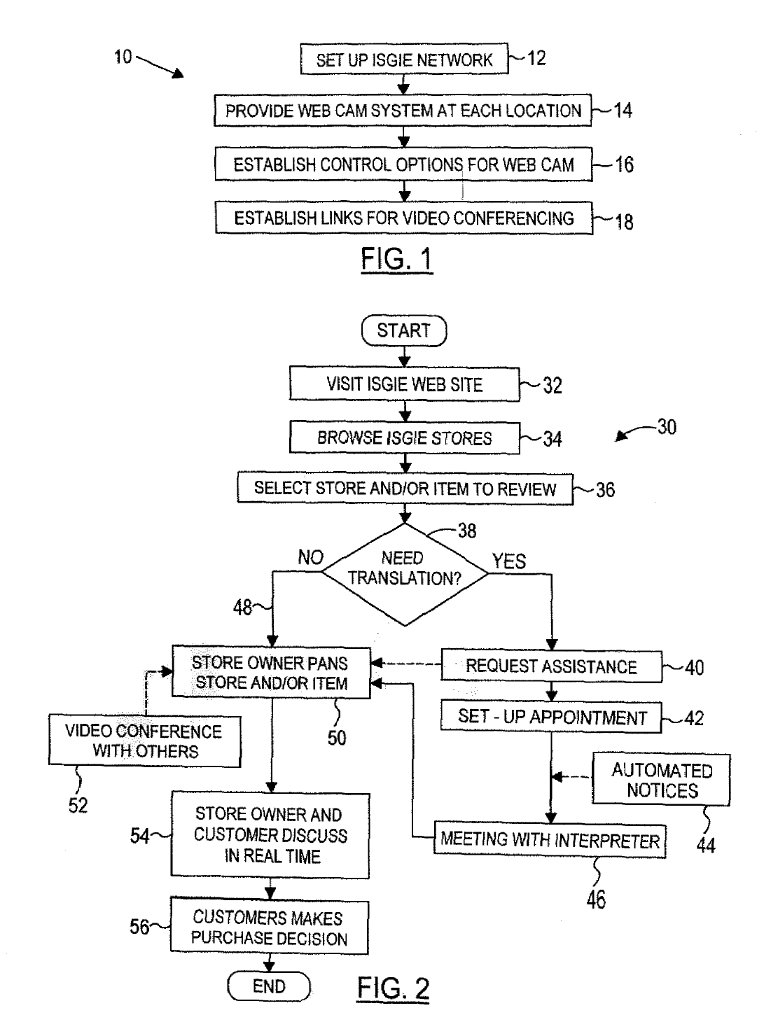

A preferred embodiment of the present invention is a unique international online shopping opportunity where the customers or prospective customers can locate a store which is associated with the system and can participate in the guided shopping experience. As a first step, participating stores will enroll or join up with the online network system in order to be part of it. For convenience, this network and system will be called the “International Shopping Guided Internet Experience”, or “ISGIE”. Each of the stores or business entities will have a web cam system installed in or at their location and will be reachable through the ISGIE network. As shown in FIG. 1, the installation system and location or business entity is shown and identified generally by the reference numeral 10. The ISGIE network is set up as shown by Box 12. Web cam systems are set up in each of the locations. This is shown by Box 14. The control options, as shown in Box 16, are then set up for each of the web cams. At the same time, links are established for video conferencing. This is shown in Box 18.

The web cams can be of any conventional type, such as commercial digital video cameras with USB connectors to personal computers. The control options for the web cams will preferably allow the cameras to be controlled by the owner or shopkeeper himself, the customer or prospective customer, or a third party participating by video conferencing. The operation of the web cam can change between the shopper, store owner, or other interested parties in accordance with their desires during their conference or meeting. Preferably, the web cams will allow wide angle panning of the entire store area showing all of the merchandise available, as well as being able to zoom in on items of interest. In addition, an owner or shopkeeper can hold the item of interest and orientate it in different positions so that the person or persons viewing the object through the ISGIE network can ascertain other relevant information about the merchandise, such as its size and overall configuration.

The real time interaction between the store owner or business owner on the one hand and the customer or prospective customer on the other hand, also allows the parties to share information, ask questions, and inquire about related matters. This, of course, is not possible on most internet shopping sites at the present time.

When either the business owner or customer/prospective customer have a language barrier, the ISGIE network and system provides the ability to secure a translator and thus for the parties to effectively complete their transaction. The translation services are available worldwide at any time of the day and any day of the year, and are available preferably in 100 or more different languages. The ISGIE network preferably is worldwide with businesses and store owners in numerous countries being part of the ISGIE network and having web cam systems at their locations. At the point it is apparent a translator is needed, which may be at the time of the initial contact, such assistance is requested through the ISGIE network and translation services are either acquired immediately or an appointment is scheduled for the presence of an interpreter at a later time and/or date. In this regard, the ISGIE network will have on hand for immediate service persons who can act as translators in virtually every major language in the world.

Where a translator is utilized, there are two ways to obtain the service. One way is either the customer or the owner decides to invite the translator who is standing by 24 ×7 to the conversation through telephone or real time and the other way is to make an appointment for the on-line conversation. For the former case, the caller operates a “translator” icon on the ISGIE computer screen and in a short time, preferably about 20 to 30 seconds, a translator will join by telephone to the conversation. For the latter case, automated messages are sent automatically from the ISGIE network to all of the parties from the translator in order to advise everyone of the scheduled time. The automated messages also will account for the time zone differences between the parties in the various parts of the world.

At this point, it is also possible for the parties to communicate through a chat room as set up through the ISGIE network. In this regard, there are numerous free chat rooms available on the internet which can be utilized and there also are numerous instant messenger services available.

The web cam in the business location also can double as a security camera when it is not in use for commercial operations.

The business owner or shopkeeper can communicate with the customer or prospective customer and the interpreter/translator, for example, through one of the free internet telephone services, such as SKYPE network. SKYPE can function either computer-to-computer or computer-to-land line. Other free video conferencing systems which can be utilized are the Microsoft and Yahoo systems. Although SKYPE is typically limited to two parties, the ISGIE network also provides links for video conferencing. Preferably, the video conferencing is provided through a charged web conference system, such as WebX which has a more robust communication platform with acceptable responsive customer services. Charged web conference systems typically allow up to 10-50 parties to participate in an on-line web cam meeting.

FIG. 2 is a flow diagram illustrating use of the present invention from the point of view of the customer or prospective customer. The flow chart is indicated generally by the reference numeral 30. As shown in Box 32, the customer/prospective customer first visits the ISGIE website. Then, as shown in Box 34, the customer browses the businesses and stores included in the ISGIE network and selects a store or business that that customer wants to explore further. This is shown in Box 36. At this point, it is typically decided whether or not a translator is needed. This is shown in Box 38. If a translator is needed, then the customer or prospective customer requests assistance. This is shown in Box 40. Thereafter, as explained above, either a translator is secured immediately, or an appointment is set up as shown in Box 42. If an appointment is set up, automated notices are sent out relative to the scheduled time as shown in Box 44. Thereafter, the meeting is commenced with the business owner, customer/prospective customer, and interpreter in attendance. This is shown in Box 46. Thereafter, the situation concerning the store owner and customer/prospective customer proceeds in the same manner as if a translation was not needed. This is shown by Decision Arrow 48.

Thereafter, the web cam is operated in accordance with the desires of the store owner and the customer/prospective customer. This typically will provide further details of the objects in question. This is shown in Box 50. If other persons are needed for the meeting or brought into the conversation through video conferencing, they can be added at this point. This is shown in Box 52.

Thereafter, the store owner and customer discuss the issues and prospective sale in real time. This is shown in Box 54. The customer then makes a purchasing decision, as shown in Box 56. If the customer decides not to make the purchase, the call is ended. If the customer decides to acquire the object or objects that were viewed during the conference, then the transaction is consummated in a conventional manner, again using the ISGIE network.

As an example for use of the present invention, an art buyer is interested in purchasing a work of art, such as a painting, from a gallery or other business. The art buyer also wants to have on line an appraiser, interior decorator, and other parties to assist in the decision of whether or not to purchase the work of art. The art buyer logs onto the ISGIE website and commences the meeting with the store owner. The other parties are brought into the conversation through video conferencing. If there are language difficulties between the parties, or if there is a belief that there may be, then a translator is secured to participate in the conference. The securing and selection of the translator is carried out in the manner as set forth above.

A full functionality meeting is allowed to take place between the parties with interactive voice capabilities using the internet telephone service. The web cam is manipulated by one or more of the parties in the conference call in order to view the work of art from many different directions and perspectives. Thereafter, either during that conference call, or at a subsequent call, the art buyer and seller can complete the transaction for the work of art as desired.

As another example, the ISGIE network is set up in a store which sells sports equipment, including golf clubs. The buyer is a golfer from another country and does not speak the same language. The buyer visits the ISGIE website, selects the store as desired, and the parties set up a translator on the spot or for a future time. Thereafter, the buyer communicates with the store owner through the translator and makes inquiries concerning various golf equipment. With the web cam, not only can the entire store and line of merchandise be viewed by the prospective buyer, but the actual golf equipment at issue can be displayed and viewed from all desired directions. Thereafter, if the buyer is satisfied with the equipment and the price is agreed to between the store owner and customer, the transaction is consummated in the conventional manner.

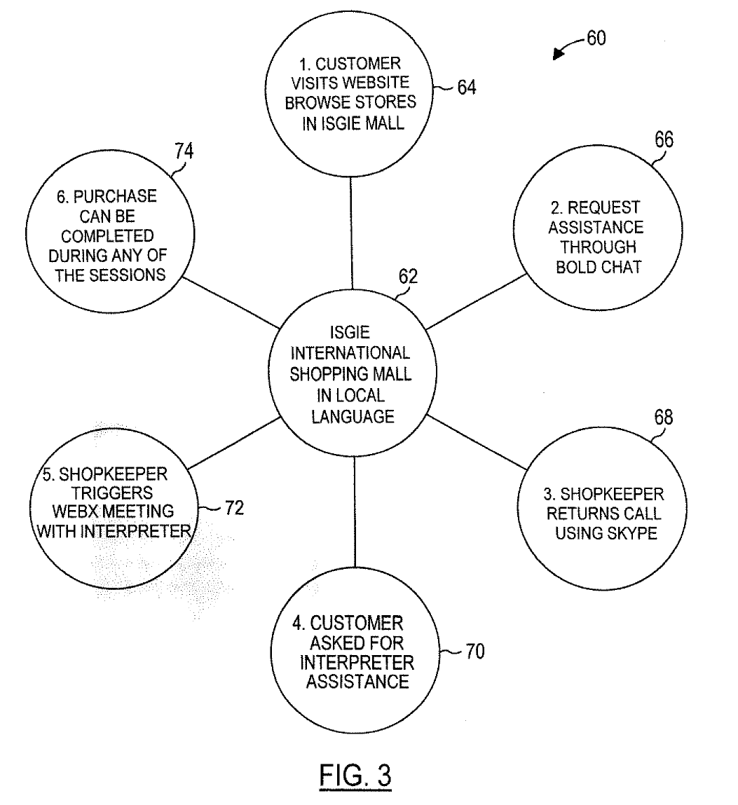

FIG. 3 illustrates another alternate form of the present invention. This embodiment is referred to generally by the reference numeral 60. An ISGIE international shopping mall in a local language is established. This is illustrated in Circle 62. Thereafter, a customer visits the ISGIE website and browses stores in the ISGIE mall. This is shown in Circle 64. Thereafter, if assistance is needed, it is requested through Bold Chat. This is shown in Circle 66. The shopkeeper returns the call using SKYPE. This is shown in Circle 68. If the interpreter is needed, the customer will ask for interpreter assistance and either a real time 24/7 service is provided, or an appointment is scheduled. This is shown in Circle 70. The shopkeeper then triggers WebX meeting with the interpreter at that point in time. This is shown in Circle 72. The purchase of the product or goods that are being viewed can be completed at any one of the sessions. This is shown in Circle 74.

While particular embodiments of the invention have been shown and described, numerous variations and alternative embodiments will occur to those skilled in the arm. Accordingly, it is intended that the invention be limited only in terms of the appended claims.

What is claimed is:

1. A method for online interactive shopping for a shopper comprising the steps of:
visiting an interactive website, said website having a plurality of members with on site cameras;
selecting a first member to contact;
contacting said first member;
reviewing merchandise at said first member through the on site camera at said first member; and
conversing directly with personnel at said first member relative to said merchandise.

2. The method as described in claim 1 further comprising the step of securing translation services in order to converse directly with said personnel.

3. The method as described in claim 1 wherein said review of merchandise comprises controlling said camera to provide views of the premises of said first member.

4. The method as described in claim 1 wherein said review of merchandise comprises controlling said camera to provide a plurality of views of said merchandise.

5. The method as described in claim 1 further comprising the step of acquiring said merchandise from said first member.

6. The method as described in claim 1 further comprising the step of connecting third parties to said conversations between said shopper and said personnel of said first member.

7. The method of operating an online interactive shopping system comprising the steps of:
establishing a network of businesses with merchandise for sale;
setting up web cams in each of said businesses;
setting up a main website and connecting said businesses to said website;
allowing shoppers to visit said website and select at least one of said businesses to contact; and
controlling said web cams at said businesses to provide information to shoppers concerning the merchandise for sale.

8. The method as described in claim 7 further comprising the step of providing direct oral communication between said shoppers and personnel of said businesses.

9. The method as described in claim 8 further comprising the step of providing video conferencing to allow third parties to participate in said oral communications.

10. The method as described in claim 8 further comprising the step of providing translation services where needed to enhance communication between said shopper and personnel of said businesses.
